(19) United States
(12) Patent Application Publication
(10) Pub. No.: US 2008/0098105 A1
(43) Pub. Date: Apr. 24, 2008

(54) Method, apparatus, and system for communication-information management, wireless-communication device, and relay device

(75) Inventor: Yoshiyuki Okada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/898,927

(22) Filed: Sep. 17, 2007

Related U.S. Application Data
(63) Continuation of application No. PCT/JP2005/004814, filed on Mar. 17, 2005.

(51) Int. Cl. G06F 15/173

(52) U.S. Cl. 709/223

(57) ABSTRACT

An access-point device authenticates a cellular phone capable of peer-to-peer communication, and connects the cellular phone to the Internet. The access-point device relays data communication between the cellular phone and a contents-provider server or a company server when a communication-information management apparatus permits the data communication. The communication-information management apparatus stores therein information related to the data communication, and charges a value for the data communication based on the information.

### BACKGROUND OF THE INVENTION

1. Field of the Invention

The present invention relates to a technology for managing information related to data communication.

2. Description of the Related Art

Communication based on communication systems such as infrared communication based on the IrDA standards, wireless local area network (LAN) communication based on the IEEE802.1X, and Bluetooth communication can be realized between a plurality of information terminals such as cellular phones or personal computers.

In a field of cellular phones that have been in widespread use, because normal public lines have a low communication speed, peer-to-peer communication between cellular phones by using the above communication systems has attracted attention, but is in little growth due to competition between carriers that provide cellular-phone services.

For example, Japanese Patent Application Laid-open No. 2003-333079 discloses a conventional technology for distributing contents via peer-to-peer communication. In such a peer-to-peer communication system, for example, when a first wireless terminal that has received contents from a contents-distribution server transfers the contents to a second wireless terminal, a coupon or a point for deducting a part from a value for the contents is issued to the first wireless terminal.

Japanese Patent Application Laid-open No. 2002-209028 discloses another conventional technology of charging a proper value for data relay performed by a relay terminal in a case that data is transmitted via the relay terminal from a source terminal to a destination terminal both made up of an ad-hoc network.

However, in the above conventional technologies, it is difficult for a provider to provide a service of distributing company data only between specified terminals.

It means that, if contents is transmitted via a plurality of terminals, it is impossible to follow routes along which the contents is transmitted, so that a range where the contents is distributed cannot be restricted according to the above methods.

Specifically, in the former conventional technology, if a terminal that is out of a communication coverage by the contents-distribution server receives the contents as result of transmission of the contents by a plurality of terminals, it is impossible to check which terminal receives the contents. In other words, it is impossible to distribute the contents only between predetermined terminals.

In the latter conventional technology, a charging terminal only charges a value to the relay terminal that relays data. That is, the charging terminal does not control distribution of the contents.

Thus, there is a need of a technology of realizing a highly reliable service capable of distributing data of a company only between specified devices as well as ensuring benefit of a service provider that provides the service.

### SUMMARY OF THE INVENTION

It is an object of the present invention to at least partially solve the problems in the conventional technology.

According to an aspect of the present invention, a method of managing information related to peer-to-peer data communication between wireless-communication devices or information related to data communication relayed by a relay device, the relay device relaying, upon successfully authenticating a wireless-communication device and connecting the wireless-communication device to a network, data communication between the wireless-communication device and a network-connected device that is connected to the network, includes determining permission for data communication between the wireless-communication device and the relay device or between the wireless-communication devices; performing the data communication upon permitting the data communication; storing information related to the data communication; and charging a value for the data communication based on the information stored at the storing.

According to another aspect of the present invention, an apparatus that manages information related to peer-to-peer data communication between wireless-communication devices or information related to data communication relayed by a relay device, the relay device relaying, upon successfully authenticating a wireless-communication device and connecting the wireless-communication device to a network, data communication between the wireless-communication device and a network-connected device that is connected to the network, includes determining unit that determines permission for data communication between the wireless-communication device and the relay device or between the wireless-communication devices; a storage unit that stores therein information related to the data communication when the data communication is performed; and a charging unit that charges a value for the data communication based on the information stored in the storage unit.

According to still another aspect of the present invention, a wireless-communication device that performs wireless communication with other devices, includes a storage unit that stores therein data received via peer-to-peer communication from other wireless-communication devices, or data received from a relay device, the relay device relaying, upon successfully authenticating the wireless-communication device and connecting the wireless-communication device to a network, data communication between the wireless-communication device and a network-connected device that is connected to the network; an inquiring unit that inquires of a management apparatus, which determines permission for data communication and charges a value for the data communication, about permission for data communication with the relay device or a second wireless-communication device; a transmitting unit that transmits the data stored in the storage unit to any one of the relay device and the second wireless-communication device upon the management apparatus permitting the data communication; and a notifying unit that notifies the management apparatus of information related to data transmission.

According to still another aspect of the present invention, a relay device that relays the data communication between the wireless-communication device and a network-connected device that is connected to a network, includes an authenticating unit that authenticates a wireless-communication device when a management apparatus, which determines permission for data communication and charges a value for the data transmission, permits the wireless-communication device to perform data communication; a connecting unit that connects the wireless-communication device to the network; a storage unit that stores therein data received from any one of the wireless-communication device and the network-connected device; a transmitting unit that transmits the data received from the network-connected device to the wireless-communication device, and that transmits the data received from the wireless-communication device to the network-connected device; and a notifying unit that notifies the management apparatus of information related to data transmission.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram of a communication-information management system according to an embodiment of the present invention;

FIG. 2 is a functional block diagram of the communication-information management system;

FIG. 3 is an example of subscriber data shown in FIG. 2;

FIG. 4 is an example of relay-provider data shown in FIG. 2;

FIG. 5 is a flowchart of a contents-transfer process performed by an access-point device shown in FIG. 1;

FIG. 6 is a flowchart of a contents-transmitting process performed by a cellular phone shown in FIG. 1;

FIG. 7 is a flowchart of a communication-information management process performed by a communication-information management apparatus shown in FIG. 1;

FIG. 8 is a schematic diagram of a hardware configuration of a computer functioning as the access-point device;

FIG. 9 is a schematic diagram of a hardware configuration of a computer functioning as the cellular phone; and

FIG. 10 is a schematic diagram of a hardware configuration of a computer functioning as the communication-information management apparatus.

### DETAILED DESCRIPTION OF THE PREFERRED EMBODIMENTS

Exemplary embodiments of the present invention are described in detail below with reference to the accompanying drawings.

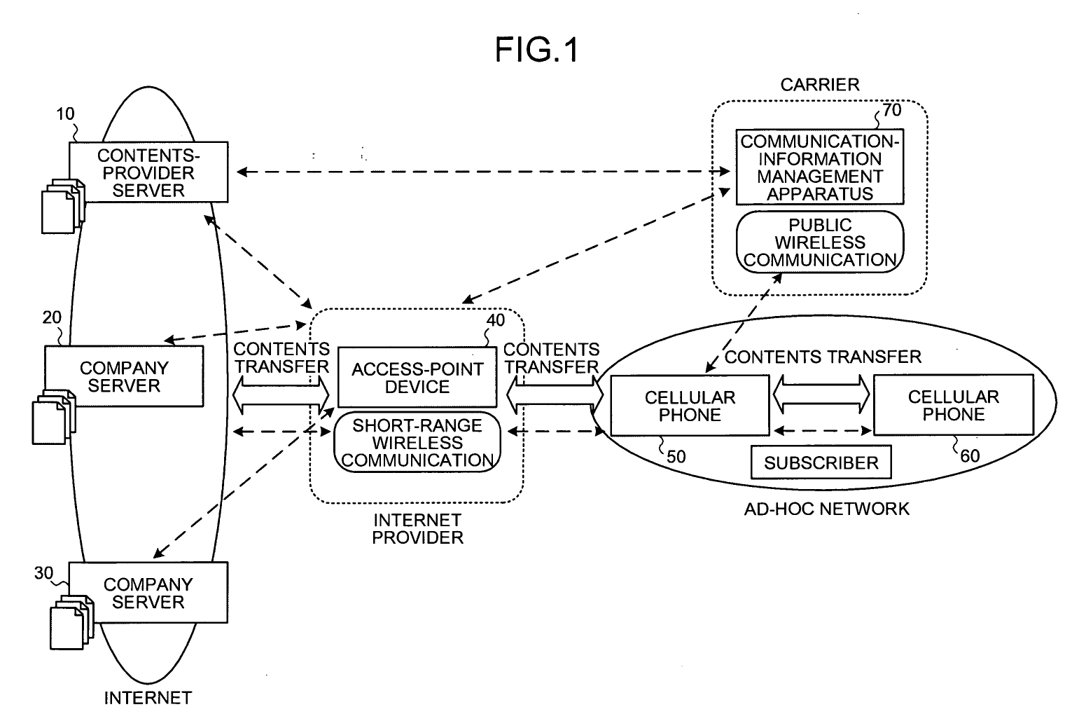

FIG. 1 is a conceptual diagram of a communication-information management system according to an embodiment of the present invention. The communication-information management system includes a contents-provider server 10, company servers 20 and 30, an access-point device 40, cellular phones 50 and 60, and a communication-information management apparatus 70.

The contents-provider server 10 stores therein contents to be provided to other devices via the Internet. For the cellular phone 50 and 60, the contents-provider server 10 provides contents to them via the access-point device 40 or the communication-information management apparatus 70.

The company server 20 or 30 is used by a company transmitting or receiving contents to or from other devices via the Internet.

The access-point device 40 is installed by an internet provider and functions as an access point via which the cellular phone 50 or 60 is connected to the Internet. The access-point device 40 receives from the cellular phone 50 or 60 a request for access to the Internet, and permits, when the request is authenticated, the cellular phone 50 or 60 to access the Internet.

The cellular phone 50 or 60 performs data communication with the communication-information management apparatus 70 installed by a carrier (telecommunications carrier) via a public line by using wireless communication. The cellular phone 50 or 60 also performs two-way data communication with the access-point device 40 through short-range wireless communications such as wireless LAN, Ultra WideBand (UWB), Infrared Data Association (IrDA), and Bluetooth.

The cellular phone 50 or 60 also performs the two-way data communication with the other one of them by using peer-to-peer communication thereby building an ad-hoc network.

The communication-information management apparatus 70 is a server installed by the carrier and that provides contents for the cellular phone 50 or 60 of a subscriber who has subscribed to the carrier.

The communication-information management apparatus 70 permits the cellular phone 50 or 60 to transmit the contents to the other one of them, in addition to providing contents for the cellular phone 50 or 60.

The communication-information management apparatus 70 also collects information related to a process of transmitting the contents performed by the contents-provider server 10, the access-point device 40, or the cellular phone 50 or 60, and charges a value to each of them.

For example, when the contents is transmitted from the contents-provider server 10 to the cellular phone 50 via the access-point device 40, an entry is made on the credit side of the account of the contents provider that owns the contents-provider server 10 for the contents. Also, an entry is made on the debit side of the account for a commission. That is, the contents provider receives or pays the balance of the account.

When the internet provider that owns the access-point device 40 transmits the contents to the cellular phone 50 or 60, or receives the contents from the cellular phone 50 or 60 and transfers received contents to the Internet, an entry is made on the credit side of the account of the internet provider for transferring the contents. That is, the internet provider is paid for the contents transfer.

For transferring contents to another cellular phone, an entry is made on the credit side of the account of a first subscriber, an owner of the cellular phone 50 that transfers the contents to the other cellular phone, and the first subscriber is paid for the contents transfer. An entry is made on the debit side of the account of a second subscriber, an owner of the cellular phone 60 that receives the contents, and the second subscriber pays for the contents transfer.

As described above, when the contents is transmitted to the cellular phone 50 or 60 via the Internet and the access-point device 40, or when the contents is transmitted from the cellular phone 50 or 60 to the company server 20 or 30 that is connected to the Internet via the access-point device 40, the communication-information management apparatus 70 gives a permission of the communication access thereby increasing reliability in the communication. Moreover, a corresponding account is charged to those involved in transmission of the contents, which makes it possible to realize a highly reliable service capable of distributing company data only between the cellular phones 50 and 60 while securing benefit of a service provider that provides the service.

Furthermore, data communication is performed between the cellular phone 50 or 60 and the access-point device 40 by using the high-speed short-range wireless communication, instead of between the cellular phone 50 or 60 and the communication-information management apparatus 70 by using the low-speed public wireless communication. As a result, it is possible to reduce load on the communication-information management apparatus 70 and efficiently transmit or receive a large amount of data.

Moreover, because the cellular phone 50 or 60 is capable of not only downloading the contents from the contents-provider server 10 or the company server 20 or 30, but also uploading data, it is possible to easily conduct a questionnaire survey by causing users to download a questionnaire and then upload answers to the questionnaire.

Still moreover, if the cellular phone 50 or 60 performs differential compression, i.e., uploading only an updated part from among data that has been downloaded, the differential compression is offset against a low data transfer rate, so that data is uploaded in a shorter period.

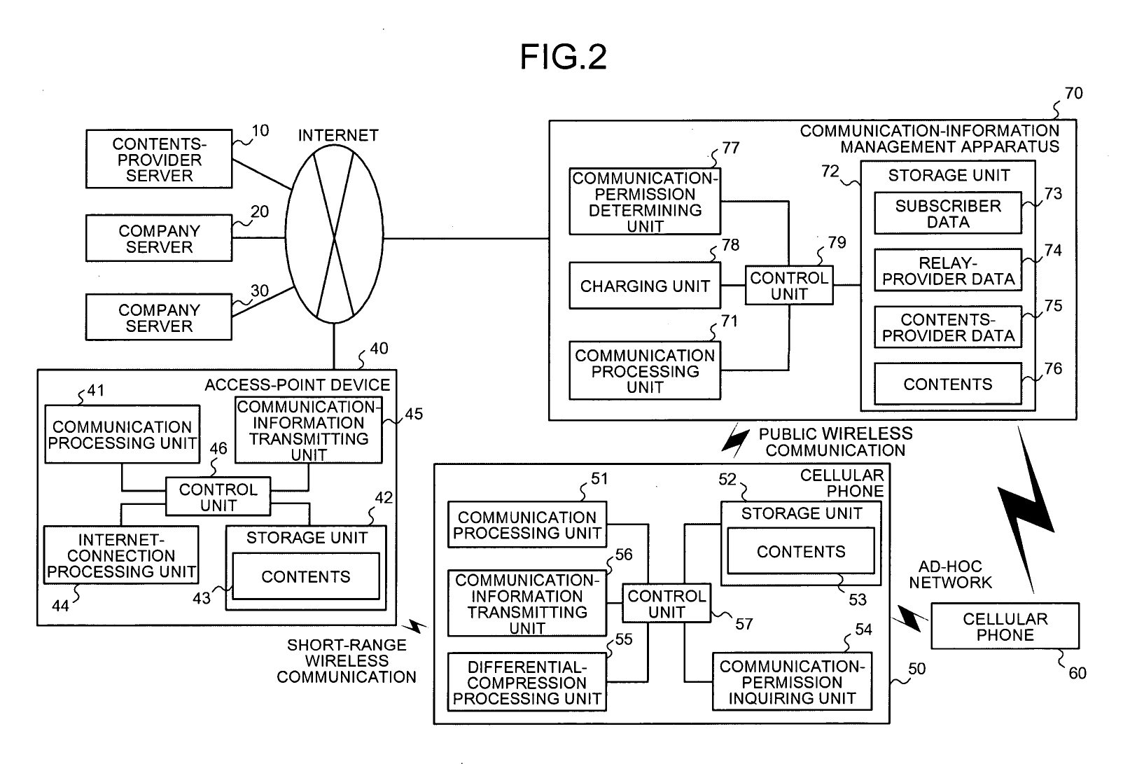

FIG. 2 is a functional block diagram of the communication-information management system. The contents-provider server 10 and the company servers 20 and 30 have functions similar to those of a personal computer or a workstation that is commonly used. Therefore, functional units included therein are not shown in FIG. 2.

The access-point device 40 includes the access-point device 40, a communication processing unit 41, a storage unit 42, an internet-connection processing unit 44, a communication-information transmitting unit 45, and a control unit 46.

The communication processing unit 41 communicates with the contents-provider server 10 or the company server 20 or 30 via the Internet. The communication processing unit 41 also performs the short-range wireless communication based on a communication system such as wireless LAN, UWB, and IrDA with the cellular phone 50 or 60.

The storage unit 42 temporarily stores therein data such as contents 43 received from the contents-provider server 10, the company server 20 or 30, or the cellular phone 50 or 60.

Upon receiving a request for access to the Internet from the cellular phone 50 or 60, the internet-connection processing unit 44 transmits to an authentication server (not shown) user information including an ID or a password received from the cellular phone 50 or 60, and connects, when the cellular phone 50 or 60 is authenticated, the cellular phone 50 or 60 to the Internet.

When the contents are transmitted or received to or from the contents-provider server 10, the company server 20 or 30, or the cellular phone 50 or 60, the communication-information transmitting unit 45 transmits to the communication-information management apparatus 70 information related to transmission/reception of the contents.

The control unit 46 controls the access-point device 40, and controls data transmission/reception between the functional units.

The cellular phones 50 and 60 are of like configuration, and thus but one of them, the cellular phone 50 is shown in detail in FIG. 2. The cellular phone 50 includes a communication processing unit 51, a storage unit 52, a communication-permission inquiring unit 54, a differential-compression processing unit 55, a communication-information transmitting unit 56, and a control unit 57.

The communication processing unit 51 performs the public wireless communication with the communication-information management apparatus 70, the short-range wireless communication with the access-point device 40, and peer-to-peer communication with the cellular phone 60.

The storage unit 52 stores therein data such as contents received from the access-point device 40 or the cellular phone 60.

When the cellular phone 50 transmits the contents to the access-point device 40 or the cellular phone 60, the communication-permission inquiring unit 54 inquires of the communication-information management apparatus 70 whether it is permitted to transmit.

The differential-compression processing unit 55 uploads, when contents that have been downloaded via the Internet is partially changed and partially-changed contents are uploaded, only an updated part that is different from the downloaded contents. Upon receiving the updated part, the company server 20 or 30 creates whole contents from the updated part and the original contents.

The control unit 57 controls the cellular phone 50, and controls data transmission/reception between the functional units.

The communication-information management apparatus 70 includes a communication processing unit 71, a storage unit 72, a communication-permission determining unit 77, a charging unit 78, and a control unit 79.

The communication processing unit 71 communicates with the contents-provider server 10, the company server 20 or 30, or the access-point device 40 via the Internet, and also performs the public wireless communication with the cellular phone 50 or 60.

The storage unit 72 stores therein data such as subscriber data 73, relay-provider data 74, contents-provider data 75, and contents 76.

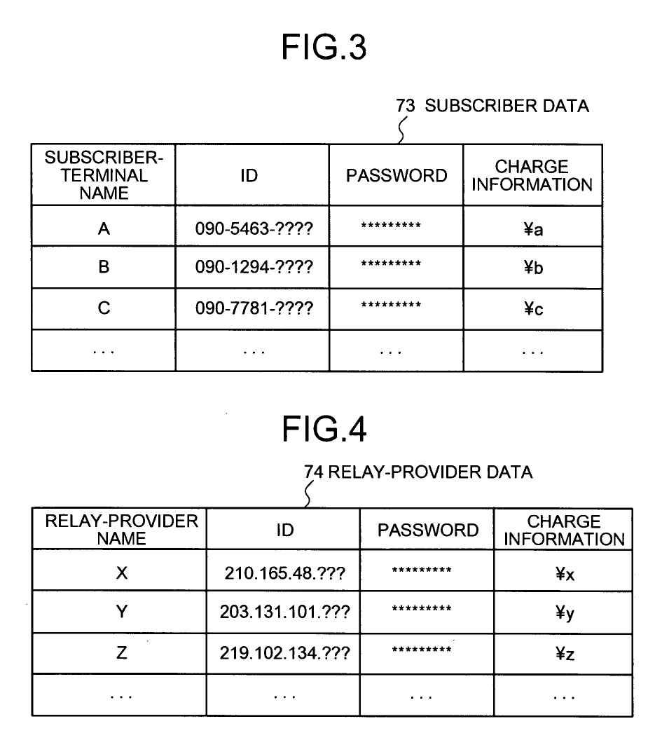

The subscriber data 73 is information on subscribers who has subscribed to communication services using the cellular phone 50 or 60 provided by the carrier. FIG. 3 is an example of the subscriber data 73.

For example, the subscriber data 73 includes subscriber-terminal name, ID, password, and charge information. The subscriber-terminal name identifies the cellular phone 50 or 60. The ID is, for example, a telephone number assigned to each of the cellular phone 50 and 60. The password is used for accessing the communication-information management apparatus 70, from the cellular phone 50 or 60, to, for example, check the charge information. The charge information indicates fees charged to each of the cellular phone 50 or 60.

The relay-provider data 74 is information on internet providers that are provided with the access-point device 40 under a contract of communication services with the carrier. FIG. 4 is an example of the relay-provider data 74.

For example, the relay-provider data 74 includes relay-provider name, ID, password, and charge information. The relay-provider name identifies the internet provider that installs the access-point device 40. The ID is an IP address of the internet provider. The password is used for accessing the communication-information management apparatus 70, from the internet provider, to, for example, check the charge information. The charge information indicates fees charged to the internet provider.

The contents-provider data 75 is information on contents providers that provide the cellular phone 50 or 60 with contents. For example, the contents-provider data 75 includes IP address for specifying a server of the contents provider, and charge information on fees charged to the contents provider.

The contents 76 is contents to be distributed to the cellular phone 50 or 60 or contents received from the cellular phone 50 or 60.

Referring back to FIG. 2, upon receiving from the cellular phone 50 or 60 a request to inquire whether it is permitted to transmit contents to the other cellular phone or the access-point device 40, the communication-permission determining unit 77 determines whether the destination terminal has subscribed to communication services by referring to the subscriber data 73 or the relay-provider data 74. When the destination terminal has subscribed to communication services, the communication-permission determining unit 77 gives the cellular phone 50 or 60 a permission for transmitting the contents.

Upon receiving from the access-point device 40 or the cellular phone 50 or 60 a contents-transmission completion message, the charging unit 78 charges a value to the contents-provider server 10, the access-point device 40, or the cellular phone 50 or 60.

The control unit 79 controls the communication-information management apparatus 70, and controls data transmission/reception between the functional units.

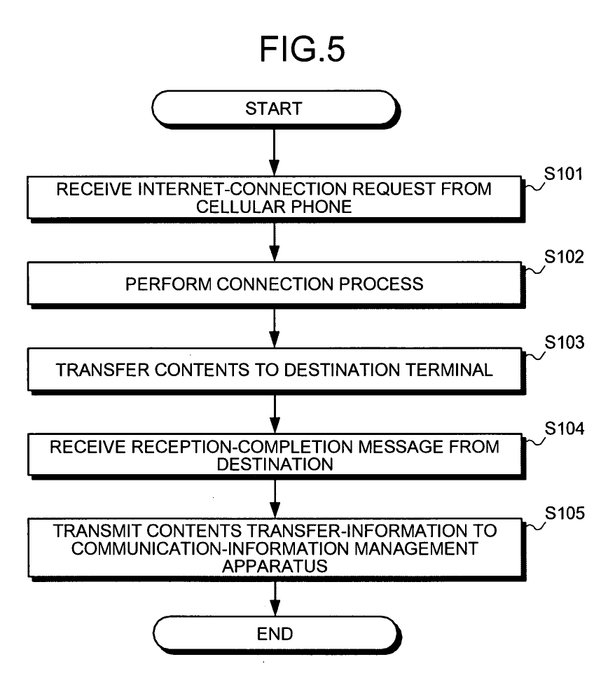

FIG. 5 is a flowchart of a contents-transfer process performed by the access-point device 40.

The internet-connection processing unit 44 receives an internet-connection request including information such as a user ID and a password from the cellular phone 50 or 60 (step S101). Thereafter, the internet-connection processing unit 44 connects the cellular phone 50 or 60 to the Internet (step S102).

Specifically, the internet-connection processing unit 44 transmits the user ID and the password that are received from the cellular phone 50 or 60 to the authentication server, and is standby until receiving a result of authentication from the authentication server. Only when the user ID and the password are authentic, the internet-connection processing unit 44 connects the cellular phone 50 or 60 to the Internet.

Subsequently, the communication processing unit 41 transfers the contents received from the contents-provider server 10 or the company server 20 or 30 to the cellular phone 50 or 60 via the Internet. Alternatively, the communication processing unit 41 transfers the contents received from the cellular phone 50 or 60 to the company server 20 or 30 via the Internet (step S103).

In a case of transmitting the contents to the company server 20 or 30 or the cellular phone 50 or 60, the communication-information transmitting unit 45 receives a message that the company server 20 or 30 or the cellular phone 50 or 60 has received the contents (step S104).

Thereafter, at the end of the contents-transfer process, the communication-information transmitting unit 45 transmits to the communication-information management apparatus 70 information indicating that the contents has been transferred (step S105). The communication-information management apparatus 70 charges a value for the contents transfer to the internet provider that manages the access-point device 40 based on this information.

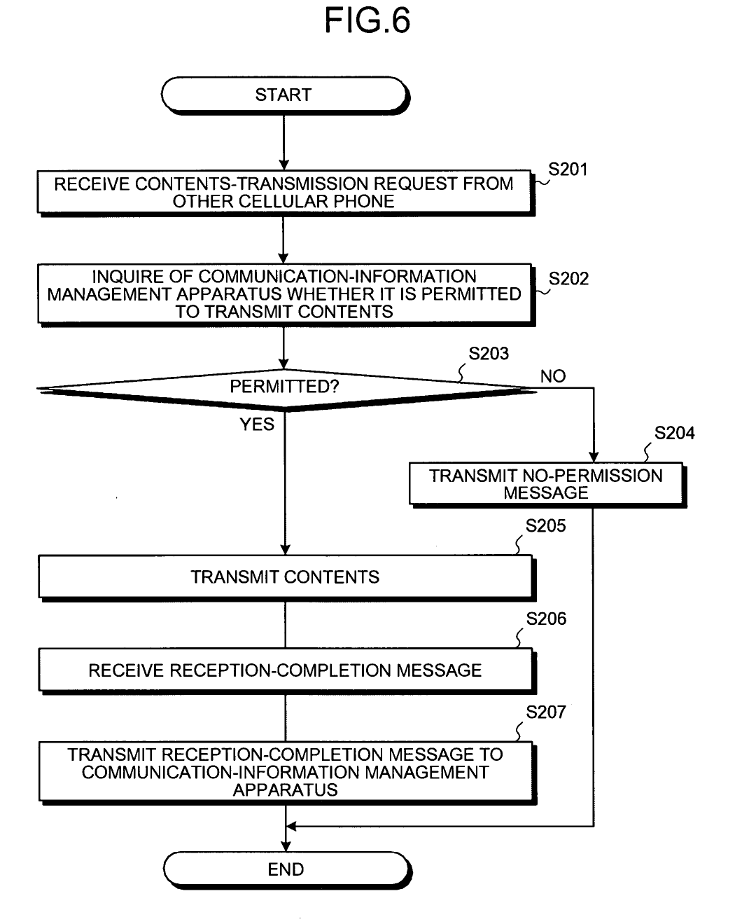

FIG. 6 is a flowchart of a contents-transmitting process performed by the cellular phone 50.

First, the communication processing unit 51 of the cellular phone 50 receives from the cellular phone 60 a request for transmitting contents to the cellular phone 60 or transmitting contents to the company server 20 via the access-point device 40 (step S201). Then, the communication-permission inquiring unit 54 inquires of the communication-information management apparatus 70 whether it is permitted to transmit the contents (step S202).

Subsequently, the communication-permission inquiring unit 54 receives a result of determination whether it is permitted to transmit from the communication-information management apparatus 70 to check whether it is permitted to transmit (step S203). When it is not permitted to transmit (No at step S203), the communication-permission inquiring unit 54 transmits a no-permission message to the cellular phone 60 (step S204).

When it is permitted to transmit (Yes at step S203), the communication-permission inquiring unit 54 transmits the contents to the cellular phone 60 or transmits the contents to the company server 20 or 30 via the access-point device 40 (step S205), and then receives a message that the cellular phone 60 or the company server 20 or 30 has received the contents (step S206).

Thereafter, at the end of the contents-transmitting process, the communication-information transmitting unit 56 transmits to the communication-information management apparatus 70 a message that the cellular phone 50 has transmitted the contents (step S207). Upon receiving this message, the communication-information management apparatus 70 makes an entry on the credit side of the account of the cellular phone 50 for the contents transfer.

Although the contents is transmitted in response to a contents-transmission request received from the cellular phone 60 in the example, the cellular phone 50 can offer the contents to the cellular phone 60.

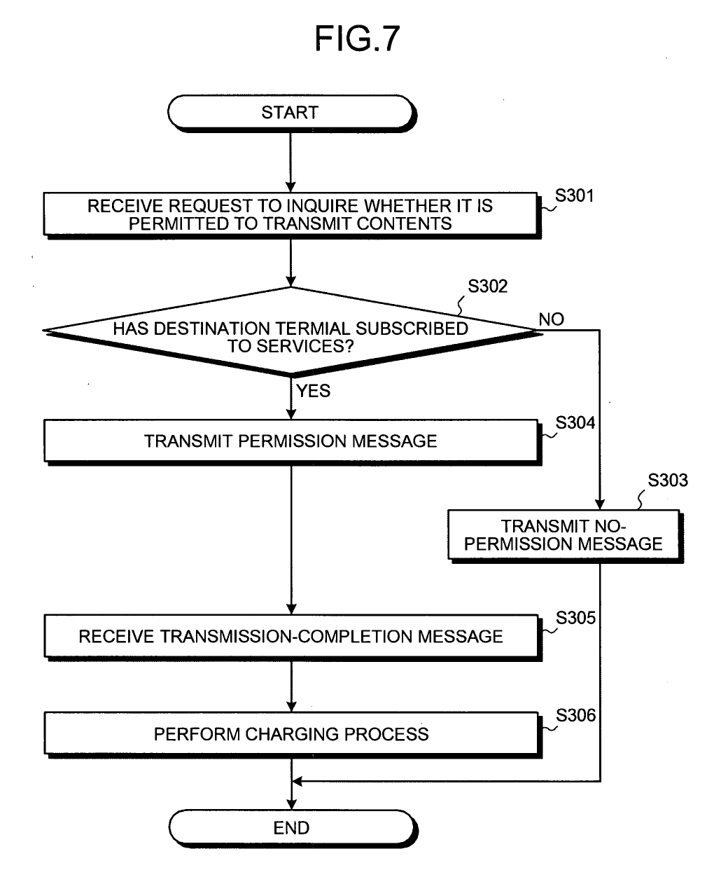

FIG. 7 is a flowchart of a communication-information management process performed by the communication-information management apparatus 70.

First, the communication processing unit 71 receives from the cellular phone 50 a request to inquire whether it is permitted to transmit the contents to the access-point device 40 or the cellular phone 60 (step S301).

Then, the communication-permission determining unit 77 checks whether an owner of the destination terminal, i.e., an internet provider that owns the access-point device 40 or an owner of the cellular phone 60 has subscribed to communication services by referring to the subscriber data 73 or the relay-provider data 74 (step S302).

When the destination terminal has not subscribed to communication services (No at step S302), the communication-permission determining unit 77 transmits a no-permission message to the cellular phone 50 that has transmitted the request to inquire whether it is permitted to transmit the contents (step S303), and the process control ends the communication-information management process.

When the destination terminal has subscribed to communication services (Yes at step S302), the communication-permission determining unit 77 transmits a permission message to the cellular phone 50 that has transmitted the request to inquire whether it is permitted to transmit the contents (step S304).

Thereafter, the communication processing unit 71 receives from the cellular phone 50 a message that the cellular phone 50 has transmitted the contents (step S305). The charging unit 78 makes an entry on the credit side of the account of the subscriber who owns the cellular phone 50 for the contents transmission, and performs a process of updating the charge information stored in the subscriber data 73 (step S306). Thus, the communication-information management process ends.

Although, in the above description, a communication is performed between the cellular phones 50 and 60 that have subscribed to communication services of the carrier, it is allowable that another cellular phone that has subscribed to communication services of the carrier relays the communication between the two cellular phones.

A relay cellular phone, i.e., the other cellular phone that relays the communication can be decided by either a cellular phone working as the transmitter of the contents or the communication-information management apparatus 70. In a case that the cellular phone working as the transmitter of the contents decides the relay cellular phone, the cellular phone working as the transmitter of the contents first obtains a permission of searching the relay cellular phone from the communication-information management apparatus 70.

Then, the cellular phone working as the transmitter of the contents requests one of the cellular phones to function as the relay cellular phone. The requested cellular phone tries to communicate with a cellular phone working as the receiver of the contents.

Upon receiving an acknowledgement of relay from the cellular phone working as the receiver of the contents as result of communication success, the requested cellular phone notifies the cellular phone working as the transmitter of the contents that relay is available. The cellular phone working as the transmitter of the contents notifies the communication-information management apparatus 70 that the relay cellular phone is decided.

In a case that the communication-information management apparatus 70 decides the relay cellular phone that relays communication, the cellular phone working as the transmitter of the contents first requests the communication-information management apparatus 70 to decide the relay cellular phone that relays communication.

Then, the communication-information management apparatus 70 obtains both an acceptance of relay from the relay cellular phone and an acknowledgement of communication via the relay cellular phone from the cellular phone working as the receiver of the contents. The communication-information management apparatus 70 notifies the cellular phone working as the transmitter of the contents that it is available to communicate with the cellular phone working as the receiver of the contents via the relay cellular phone.

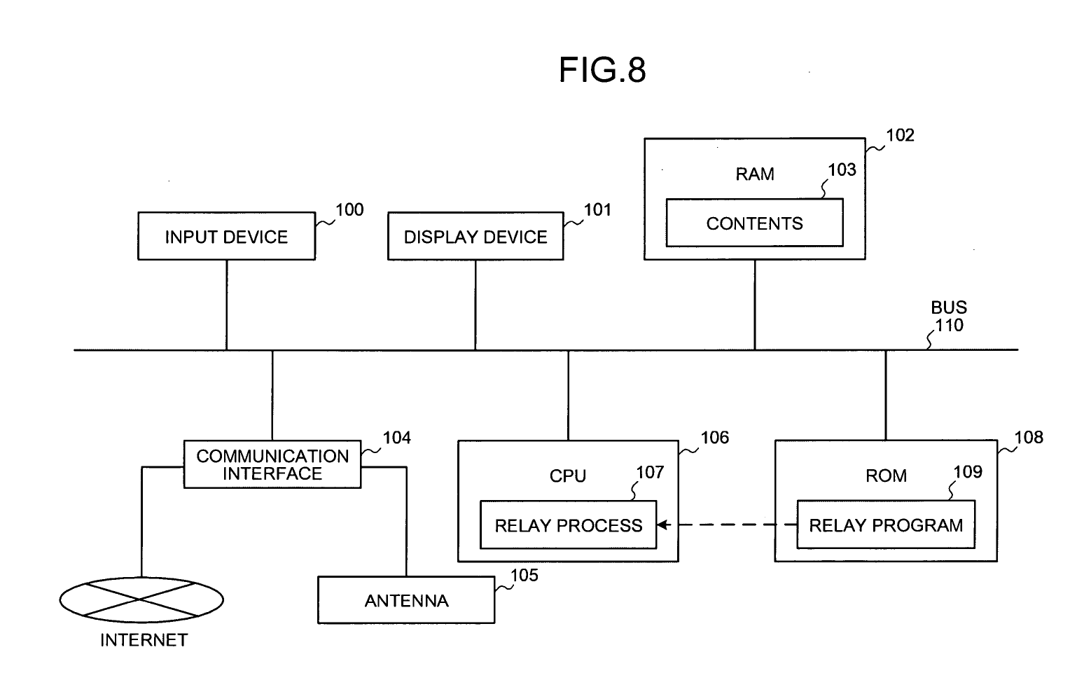

A computer program can be executed on a computer to implement the various processes described in the above embodiment. An example of such a computer is described below with reference to FIGS. 8 to 10.

FIG. 8 is a schematic diagram of a hardware configuration of a computer functioning as the access-point device 40.

This computer includes an input device 100, a display device 101, a random access memory (RAM) 102, a communication interface 104, a central processing unit (CPU) 106, and a read only memory (ROM) 108, which are connected to each other via a bus 110. The display device 101 displays state of the access-point device 40. The RAM 102 temporarily stores therein contents 103. The communication interface 104 communicates with the contents-provider server 10 or the company server 20 or 30 via the Internet or performs the short-range wireless communication with the cellular phone 50 or 60 by using an antenna 105. The ROM 108 stores therein a computer program (hereinafter, “relay program”) 109.

The relay program 109 implements, when executed, the same function as the access-point device 40. The CPU 106 reads the relay program 109 from the ROM 108 to execute it, thereby implementing a relay process 107.

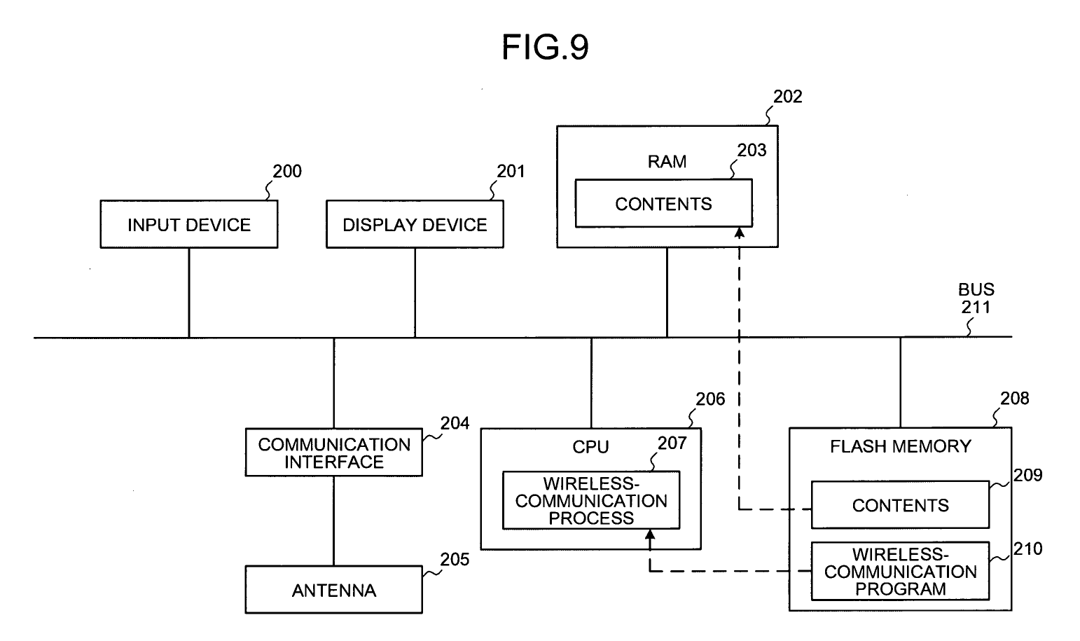

FIG. 9 is a schematic diagram of a hardware configuration of a computer functioning as the cellular phones 50 and 60.

This computer includes an input device 200, a display device 201, a RAM 202, a communication interface 204, a CPU 206, and a flash memory 208, which are connected to each other via a bus 211. The input device 200 is used by a user to provide input. The communication interface 204 performs short-range wireless communication with the access-point device 40 by using an antenna 205, public wireless communication with the communication-information management apparatus 70, or communication with the cellular phone 50 or 60

The flash memory 208 stores therein a computer program (hereinafter, “wireless-communication program) 210 that, when executed, implements the same function as the cellular phone 50 or 60. The CPU 206 reads the wireless-communication program 210 from the flash memory 208 to execute it, thereby implementing a wireless-communication process 207. The wireless-communication process 207 corresponds to functions of the cellular phone 50 or 60.

The flash memory 208 also stores therein contents 209. The contents 209 corresponds to contents 53 stored in the storage unit 52. The CPU 206 stores the contents 209 in the flash memory 208. The CPU 206 loads the contents 209 from the flash memory 208 into the RAM 202, and performs various processes by using contents 203 stored in the RAM 202.

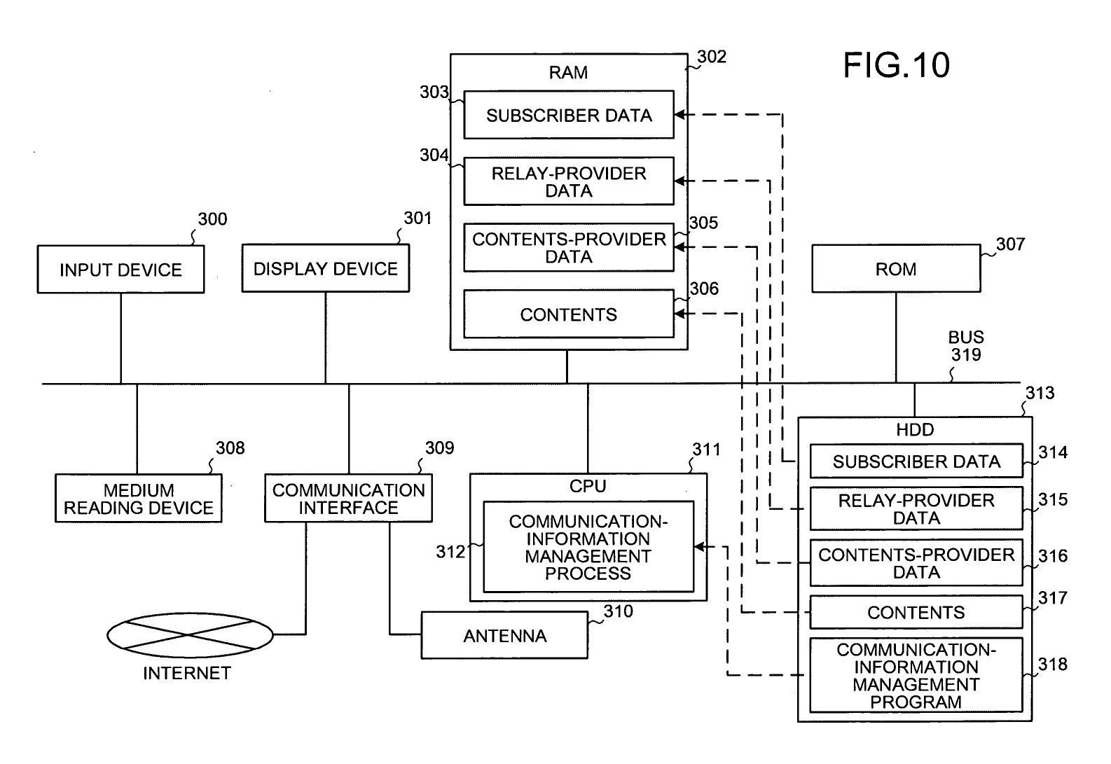

FIG. 10 is a schematic diagram of a hardware configuration of a computer functioning as the communication-information management apparatus 70.

This computer includes an input device 300, a display device 301, a RAM 302, a ROM 307, a medium reading device 308, a communication interface 309, a CPU 311, and a hard disk drive (HDD) 313, which are connected to each other via a bus 319. The input device 300 is used by a user to provide input. The medium reading device 308 reads a computer program from a recording medium that stores therein various computer programs. The communication interface 309 communicates with the access-point device 40 or the contents-provider server 10 via the Internet, or performs wireless communication with the cellular phone 50 or 60 by using an antenna 310

The HDD 313 stores therein a computer program (hereinafter, “communication-information management program) 318 that, when executed, implements the same function as the communication-information management apparatus 70. The CPU 311 reads the communication-information management program 318 from the HDD 313 to execute it, thereby implementing a communication-information management process 312. The communication-information management process 312 corresponds to functions of the communication-information management apparatus 70.

The HDD 313 also stores therein subscriber data 314, relay-provider data 315, contents-provider data 316, and contents 317. The subscriber data 314, the relay-provider data 315, the contents-provider data 316, and the contents 317 correspond to the subscriber data 73, the relay-provider data 74, the contents-provider data 75, and the contents 76, those stored in the storage unit 72, respectively.

The CPU 311 stores the subscriber data 314, the relay-provider data 315, the contents-provider data 316, and the contents 317 in the HDD 313. The CPU 311 loads those data from the HDD 313 into the RAM 302, and performs various processes based on subscriber data 303, relay-provider data 304, contents-provider data 305, and contents 306 stored in the RAM 302.

In the present embodiment as described above, data communication is performed between the cellular phone 50 or 60 and the access-point device 40, or data communication is performed between the cellular phones 50 and 60 under conditions that the communication-information management apparatus 70 determines whether communication between the cellular phones 50 and 60 is permissible and it is determined that the communication is permissible. When the data communication is performed, the communication-information management apparatus 70 stores therein information related to the data communication, and charges, based on the information, a value for the data communication performed by the cellular phone 50 or 60 or the access-point device 40. As a result, it is possible to realize a highly reliable service capable of distributing data only between specified devices as well as to ensure the benefit of a provider that provides the service.

Although the present invention has been described with reference to specific exemplary embodiments, it will be evident that various modification and changes can be made to these embodiments without departing from the broader spirit of the invention as set forth in the claims.

For example, although the cellular phones are used as wireless-communication terminals that perform peer-to-peer communication in the embodiments, other wireless-communication terminals can be used such as a PDA (Personal Digital Assistance) and a personal computer those having a wireless-communication function.

Of the processes described in the embodiments, all or part of the processes explained as being performed automatically can be performed manually. Similarly, all or part of the processes explained as being performed manually can be performed automatically by a known method.

The processing procedures, the control procedures, specific names, various data, and information including parameters described in the document or shown in the drawings can be changed as required unless otherwise specified.

The constituent elements of the device shown in the drawings are merely conceptual, and need not be physically configured as illustrated. The constituent elements, as a whole or in part, can be separated or integrated either functionally or physically based on various types of loads or use conditions.

The process functions performed by the device are entirely or partially realized by the CPU or computer programs that are analyzed and executed by the CPU, or realized as hardware by wired logic.

As set forth hereinabove, according to an embodiment of the present invention, it is possible to realize a highly reliable service capable of distributing data only between specified devices as well as to ensure benefit of a provider that provides the service.

Moreover, uploading of data can be completed in a short period of time with low data-transfer rate.

Furthermore, it is possible to transmitting and receiving a large amount of data through a high-speed data communication between a wireless-communication device and a relay device.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of managing information related to peer-to-peer data communication between wireless-communication devices or information related to data communication relayed by a relay device, the relay device relaying, upon successfully authenticating a wireless-communication device and connecting the wireless-communication device to a network, data communication between the wireless-communication device and a network-connected device that is connected to the network, the method comprising:
determining permission for data communication between the wireless-communication device and the relay device or between the wireless-communication devices;
performing the data communication upon permitting the data communication;
storing information related to the data communication; and
charging a value for the data communication based on the information stored at the storing.

2. The method according to claim 1, wherein the data communication includes uploading of data from the wireless-communication device to the network-connected device.

3. The method according to claim 2, wherein the uploading of data includes
the wireless-communication device downloading data from the network-connected device; and
the wireless-communication device uploading only updated part of the data to the network-connected device.

4. The method according to any one of claims 1, wherein the data communication between the wireless-communication device and the relay device is performed using any one of a wireless local area network, ultra wideband, infrared data association, and Bluetooth.

5. An apparatus that manages information related to peer-to-peer data communication between wireless-communication devices or information related to data communication relayed by a relay device, the relay device relaying, upon successfully authenticating a wireless-communication device and connecting the wireless-communication device to a network, data communication between the wireless-communication device and a network-connected device that is connected to the network, the apparatus comprising:
a determining unit that determines permission for data communication between the wireless-communication device and the relay device or between the wireless-communication devices;
a storage unit that stores therein information related to the data communication when the data communication is performed; and
a charging unit that charges a value for the data communication based on the information stored in the storage unit.

6. A wireless-communication device that performs wireless communication with other devices, the wireless-communication device comprising:
a storage unit that stores therein data received via peer-to-peer communication from other wireless-communication devices, or data received from a relay device, the relay device relaying, upon successfully authenticating the wireless-communication device and connecting the wireless-communication device to a network, data communication between the wireless-communication device and a network-connected device that is connected to the network;
an inquiring unit that inquires of a management apparatus, which determines permission for data communication and charges a value for the data communication, about permission for data communication with the relay device or a second wireless-communication device;
a transmitting unit that transmits the data stored in the storage unit to any one of the relay device and the second wireless-communication device upon the management apparatus permitting the data communication; and
a notifying unit that notifies the management apparatus of information related to data transmission.

7. A relay device that relays the data communication between the wireless-communication device and a network-connected device that is connected to a network, the relay device comprising;
an authenticating unit that authenticates a wireless-communication device when a management apparatus, which determines permission for data communication and charges a value for the data transmission, permits the wireless-communication device to perform data communication;
a connecting unit that connects the wireless-communication device to the network;
a storage unit that stores therein data received from any one of the wireless-communication device and the network-connected device;
a transmitting unit that transmits the data received from the network-connected device to the wireless-communication device, and that transmits the data received from the wireless-communication device to the network-connected device; and
a notifying unit that notifies the management apparatus of information related to data transmission.

8. A system that manages information related to data communication, the system comprising:
a wireless-communication device that performs peer-to-peer data communication;
a relay device that authenticates the wireless-communication device, connects the wireless-communication device to a network upon successfully authenticating the wireless-communication device, and relays data communication between the wireless-communication device and a network-connected device that is connected to the network; and
a management apparatus that manages information related to the peer-to-peer data communication or information related to the data communication relayed by the relay device, the management apparatus including
a determining unit that determines permission for data communication between the wireless-communication device and the relay device or data communication between the wireless-communication devices, and performs, upon permitting the data communication, the data communication;
a storage unit that stores therein information related to the data communication; and
a charging unit that charges a value for the data communication based on the information stored in the storage unit.
